(19) United States
(12) Patent Application Publication
(10) Pub. No.: US 2013/0309391 A1
(43) Pub. Date: Nov. 21, 2013

(54) Method for Preparing Cooked Oatmeal into a Solid Composition for Food Consumption

(71) Applicant: Steven Paul Latoski, Kingman, AZ (US)

(72) Inventor: Steven Paul Latoski, Kingman, AZ (US)

(21) Appl. No.: 13/475,958

(22) Filed: May 19, 2012

(51) Int. Cl. A23L 1/164

(52) U.S. Cl. CPC A23L 1/1648
USPC 426/627; 426/618

(57) ABSTRACT

A method for preparing cooked oat cereal into a cold, cohesive mass for convenient, ready-to-eat serving and consumption using traditional eating utensils. This food product contains two base ingredients, rolled oats and water. A uniform weight ratio of rolled oats to water is used to achieve complete cooking of all oat cereal particles using a microwave cooking process for time duration relative to the weight of rolled oats used in product preparation. A refrigeration cooling process for minimum time duration proportional to ingredient quantity is used to create a solid composition of all cooked oat cereal particles in a sealed, airtight preparation container. The resulting food product retains its mass and shape when removed from its preparation container for ready-to-eat serving or storage, and it has sufficient density and cohesion for partitioning into solid sections.

### CROSS-REFERENCE TO RELATED APPLICATIONS

Not Applicable

### BACKGROUND OF THE INVENTION

This invention produces an alternative oat cereal product comprising a solid composition for food consumption. Oats represent a commonly known and consumed grain with medically recognized benefits, and this invention provides broad consumption options through unique and varied serving presentations and food pairings. Product preparation and storage at refrigeration temperature facilitates on-demand serving.

The applicant is aware of the following patents:
U.S. Pat. No. RE34,508 to Murtaugh, et al.
U.S. Pat. No. 5,035,913 to Sky
U.S. Pat. No. 7,740,891 to Foster, et al.

None of the cited patents show a product for food consumption as (1) a cold and solid composition of cooked oat cereal particles and food grade liquid only and (2) prepared in various product quantities and containers for consumption using traditional eating utensils.

### BRIEF SUMMARY OF THE INVENTION

This invention provides a method for preparing oat cereal to broaden its food consumption options. This invention promotes serving cooked oat cereal with food spreads, toppings, and pairings not commonly combined with hot oatmeal of liquid or semi-solid consistency. Post-prepared, it enables standing, ready-to-eat serving for user convenience.

### BRIEF DESCRIPTION OF THE SEVERAL VIEWS OF THE DRAWING

Not Applicable

### DETAILED DESCRIPTION OF THE INVENTION

This invention creates a ready-to-eat food product using dry whole grain oats and food grade liquid coupled with a cooking apparatus and refrigeration apparatus. This invention establishes a unique method to prepare cooked oatmeal into solid composition for food consumption through application of certain (1) quantity ratio of oat cereal particles to liquid and (2) cooking temperature and time duration to enable transformation into a cold, cohesive mass under sufficient refrigeration time duration subsequent to cooking all oat cereal particles.

This invention method employs a greater ratio of oat cereal particles to liquid coupled with greater cooking temperature and/or greater cooking time duration to achieve a lower product liquid content compared to commonly published preparation methods for hot oatmeal cereal. In addition, the method applies a refrigeration or cooling action to the cooked product, which enables the product to form a solid composition in its sealed, airtight preparation container under sufficient refrigeration temperature and time. Once the product attains a cold, cohesive mass, the product will retain its characteristics and suitability for food consumption while under constant refrigeration for several days.

### Example 1

150 grams: whole grain rolled oats (Old Fashioned)
375 grams: municipal tap water

The dry oats and water are combined in a microwavable container having a 4-cup (0.95 liters) minimum capacity. Using a microwave cooking process, the container contents are cooked uncovered for 3 minutes and 30 seconds without interruption using a 1000 watt microwave operated at full power with rotating turntable.

After completion of the cooking process and subsequent to a few seconds elapsing as necessary for the cooked oat cereal particles to settle from a possible foam-like appearance when cooking, an airtight cover is affixed to the container to establish the product's storage state for cooling. The container is immediately placed into refrigeration for minimum time duration of six (6) hours while the product attains a cold, cohesive mass. After completion of the minimum refrigeration process, the cooked oatmeal product retains its solid composition and stands ready for user serving and consumption.

The described Example 1 can be replicated to produce any product quantity by changing the quantity of ingredients while maintaining their weight ratio. Similarly, the microwave cooking and refrigeration cooling processes are modified in time duration proportional to ingredient quantity. Example 1 uses rolled oats whereas substitution of whole grain oats with an alternative shape, thickness, or texture may require adjustment of the ingredient (oats and water) weight ratio based on the oat manufacturer's cooking instructions for the alternative oat cereal particles compared to that for rolled oats.

What is claimed is:

1. A cooked oat cereal cooled to create a solid composition of oat cereal particles, which substantially maintain mass and shape when removed from its preparation container for food consumption using traditional eating utensils.

2. The cereal of claim 1 containing 1 part rolled oats to 2.5 parts water by weight and cooked uncovered through a microwave cooking process for continuous time duration in seconds equal to 1.4 times the weight in grams of the old fashioned style rolled oats or 1.2 times the weight in grams of the quick or instant style rolled oats used in product preparation at 1,000 watt microwave operation to provide a solid composition of all cooked oat cereal particles when cooled completely in a sealed, airtight preparation container by refrigeration process for a minimum, continuous time duration in minutes equal to 2.4 times the weight in grams of the rolled oats used in product preparation.

3. The cereal of claim 1 containing one or more optional food or pharmaceutical grade additives and supplements for flavoring and/or nutrition while enabling complete cooking of all oat cereal particles and cooling to create a solid composition of all cooked oat cereal particles including such additives and supplements.
